(19) United States
(12) Patent Application Publication
(10) Pub. No.: US 2015/0234671 A1
(43) Pub. Date: Aug. 20, 2015

(54) MANAGEMENT SYSTEM AND MANAGEMENT PROGRAM

(71) Applicant: HITACHI, LTD., Tokyo (JP)

(72) Inventors: Takumi Tomita, Tokyo (JP); Takeshi Arisaka, Tokyo (JP); Hideo Takahashi, Tokyo (JP)

(73) Assignee: Hitachi, Ltd., Tokyo (JP)

(21) Appl. No.: 14/428,007

(22) PCT Filed: Mar. 27, 2013
(86) PCT No.: PCT/JP2013/058950

§ 371 Date: Mar. 13, 2015

(51) Int. Cl. G06F 9/455; G06F 9/50

(52) U.S. Cl. CPC G06F 9/45558; G06F 9/5016; G06F 2009/4557; G06F 2009/45583

(57) ABSTRACT

A management system is able to reduce a migration load, which is associated with a requested change in a system which receives a virtual machine generation request that designates a template. The system searches for a physical computer having physical resources included in the template, sends a resource allocation request to the searched physical computer in accordance with the received virtual machine generation request and the template, collects a resource usage status of each physical computer, receives an identifier of a generated virtual machine and a change request to change the template. Then, the system calculates a resource type and resource amount, which need to be added by changing the template, based on the collected resource usage status; and determines whether a first physical computer for controlling the generated virtual machine has the additional resource amount of the calculated resource type as an unused resource amount or not.

### TECHNICAL FIELD

The present invention relates to a management system and program and is suited for use in a management system and program for constructing and changing a virtual server system.

### BACKGROUND ART

In recent years, a user is provided with a virtual server system constituted from virtual machines and storage apparatuses at a data center and the operation (provisioning) to construct and change the virtual server system is performed in accordance with specifications requested by the users.

For example, regarding Patent Literature 1, a software configuration required by a business system, to which resources are allocated, is compared with software configurations of virtual server systems which can be provided, in order to curb migration costs; and the resources of the virtual server systems are grouped in the order of those having closer configuration. Then, a virtual server system which should be newly allocated to the business system in response to the request can be found quickly and an software environment which satisfies the request can be constructed.

### CITATION LIST

### Patent Literature

[Patent Literature 1] Japanese Patent Application Laid-Open (Kokai) Publication No. 2007-114983
[Patent Literature 2] Japanese Patent Application Laid-Open (Kokai) Publication No. 2007-133654
[Patent Literature 3] Japanese Patent Application Laid-Open (Kokai) Publication No. 2012-221273
[Patent Literature 4] Japanese Patent Application Laid-Open (Kokai) Publication No. 2011-123746

### SUMMARY OF INVENTION

### Technical Problem

However, Patent Literature 1 mentioned above has a problem of the necessity, when changing the software configuration of a virtual server system allocated to a business system, to always newly allocate a virtual server system and migrate the system even for a small-scale change. For example, if a request is satisfied by only changing settings of the virtual server system in a case of, for example, ability reduction of resources such as a CPU, it is desired that migration time and costs should be curbed by only changing the settings of the virtual server system without migration.

The present invention was devised in consideration of the above circumstances and is intended to suggest a management system and program capable of reducing migration loads, which are associated with a requested change, on the system.

### Solution to Problem

In order to solve the above-described problem, provided according to the present invention is a management system a management system including: a memory unit for storing a plurality of templates including a resource type and resource amount of physical resources of a plurality of physical computers allocated to a virtual machine; and a control unit for controlling allocation of the physical resources to the virtual machine; wherein each of the plurality of physical computers has the physical resources and executes a hypervisor for controlling the virtual machine; and wherein the management system: receives a virtual machine generation request which designates one template of the plurality of templates; searches for the physical computer having the physical resources included in the template; sends a resource allocation request to the searched physical computer in accordance with the received virtual machine generation request and the template; collects a resource usage status of each physical computer; receives an identifier of a generated virtual machine and a change request to change the template; calculates a resource type and resource amount, which need to be added by changing the template, based on the collected resource usage status; judges whether a first physical computer for controlling the generated virtual machine has the additional resource amount of the calculated resource type as an unused resource amount or not; sends a request to the first physical computer to additionally allocate the calculated additional resource amount from the unused resource amount, which the first physical computer has, to the generated virtual machine if the first physical computer has the additional resource amount as the unused resource amount; and sends an operation instruction to additionally allocate the calculated additional resource amount to the generated virtual machine if the first physical computer does not have the additional resource amount as the unused resource amount.

If the above-described configuration is employed and the unused resource amount of the physical computer which provides the generated virtual machine is enough for the resource type and resource amount of a resource which needs to be added in response to the resource allocation change request, the resource of the physical computer is added to the generated virtual machine; and if the unused resource amount of the physical computer which provides the generated virtual machine is not enough, an unused resource amount of another physical computer is additionally allocated. Accordingly, if the request is satisfied by only changing the settings of the system, it is only necessary to change the settings of the system without performing migration. So, migration loads, which are associated with the requested change, on the system can be reduced.

### Advantageous Effects of Invention

According to the present invention, migration loads, which are associated with a requested change, on the system can be reduced.

### BRIEF DESCRIPTION OF DRAWINGS

FIG. 1 is a conceptual diagram for explaining the outline of a first embodiment of the present invention.

FIG. 2 is a conceptual diagram for explaining the outline of the embodiment.

FIG. 3 is a block diagram showing the configuration of a computer system according to the embodiment.

FIG. 4 is a conceptual diagram for explaining a virtual server system according to the embodiment.

FIG. 5 is a block diagram showing the configuration of a management server according to the embodiment.

FIG. 6 is a block diagram showing the configuration of a server computer according to the embodiment.

FIG. 7 is a block diagram showing the configuration of a storage apparatus according to the embodiment.

FIG. 8 is a chart showing the content of a schedule table according to the embodiment.

FIG. 9 is a chart showing the content of a CPU grade table according to the embodiment.

FIG. 10 is a chart showing the content of a storage class table according to the embodiment.

FIG. 11 is a chart showing the content of a virtual server system table according to the embodiment.

FIG. 12 is a chart showing the content of a virtual server system schedule table according to the embodiment.

FIG. 13 is a chart showing the content of a hypervisor table according to the embodiment.

FIG. 14 is a chart showing the content of a template table according to the embodiment.

FIG. 15 is a chart showing the content of a disk template table according to the embodiment.

FIG. 16 is a chart showing the content of a disk table according to the embodiment.

FIG. 17 is a chart showing the content of a storage table according to the embodiment.

FIG. 18 is a chart showing the content of a storage-hypervisor related table according to the embodiment.

FIG. 19 is a chart showing the content of a server port table according to the embodiment.

FIG. 20 is a chart showing the content of a storage port table according to the embodiment.

FIG. 21 is a chart showing the content of a server port-storage port related table according to the embodiment.

FIG. 22 is a chart showing the content of a storage pool table according to the embodiment.

FIG. 23 is a chart showing the content of a storage pool-storage port related table according to the embodiment.

FIG. 24 is a chart showing the content of a search policy table according to the embodiment.

FIG. 25 is a flowchart illustrating new allocation processing according to the embodiment.

FIG. 26 is a flowchart illustrating configuration information collection processing according to the embodiment.

FIG. 27 is a flowchart illustrating update processing according to the embodiment.

FIG. 28 is a flowchart illustrating computer server search processing according to the embodiment.

FIG. 29 is a flowchart illustrating disk search processing according to the embodiment.

FIG. 30 is a flowchart illustrating migration processing according to the embodiment.

FIG. 31 is a conceptual diagram showing an example of a virtual server system management display according to the embodiment.

FIG. 32 is a conceptual diagram showing an example of a template edit display according to the embodiment.

FIG. 33 is a conceptual diagram for explaining the outline of a second embodiment.

FIG. 34 is a conceptual diagram showing an example of a template edit display according to the embodiment.

FIG. 35 is a conceptual diagram showing an example of a migration check display according to the embodiment.

### DESCRIPTION OF EMBODIMENTS

An embodiment of the present invention will be explained below in detail with reference to drawings.

Information about this invention will be explained in the description below, using expressions such as “aaa tables,” “aaa lists,” “aaa DBs,” and “aaa queues,” but these pieces of information may be expressed by structures other than data structures such as tables, lists, DBs, and queues. Accordingly, information such as “aaa tables,” “aaa lists,” “aaa DBs,” and “aaa queues,” may be sometimes called “aaa information” in order to indicate that such information does not depend on the data structures. Moreover, expressions such as “identification information,” “identifier,” “name,” and “ID” are used when explaining the content of each piece of information, but they can be replaced with each other.

The following explanation may be given by using the word “program” as a subject. However, since a program is executed by execution of specified processing by a processor using a memory and a communication port (communication control device), the processor may be used as a subject in the explanation. Also, the processing disclosed by using a program as a subject may be processing executed by a computer such as a management server or an information processing unit. Moreover, part or all programs may be implemented by dedicated hardware.

Furthermore, various programs may be installed in each computer by means of storage media which can be read by a program distribution server and the computer.

### (1) First Embodiment

### (1-1) Outline of this Embodiment

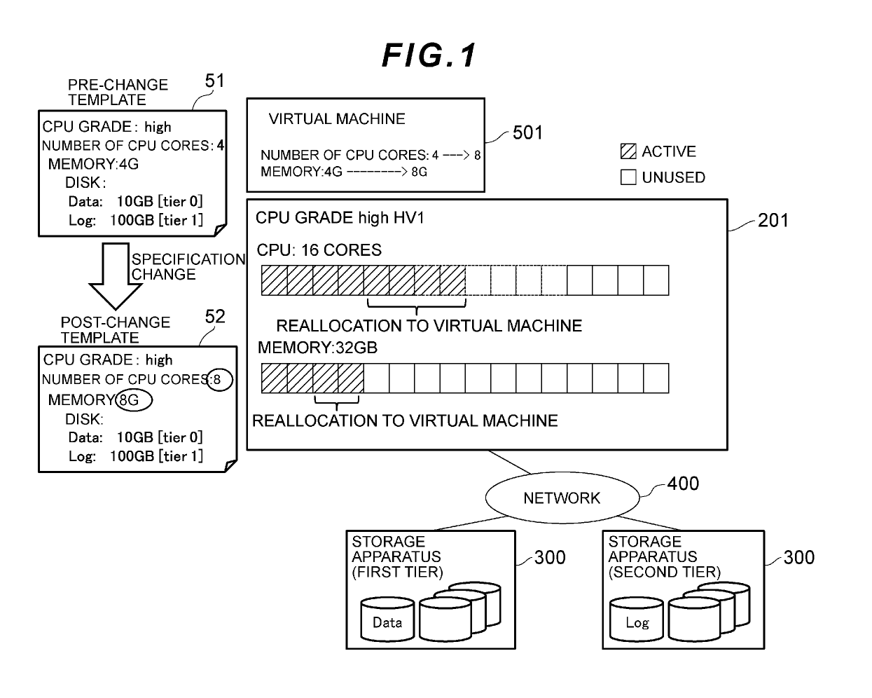

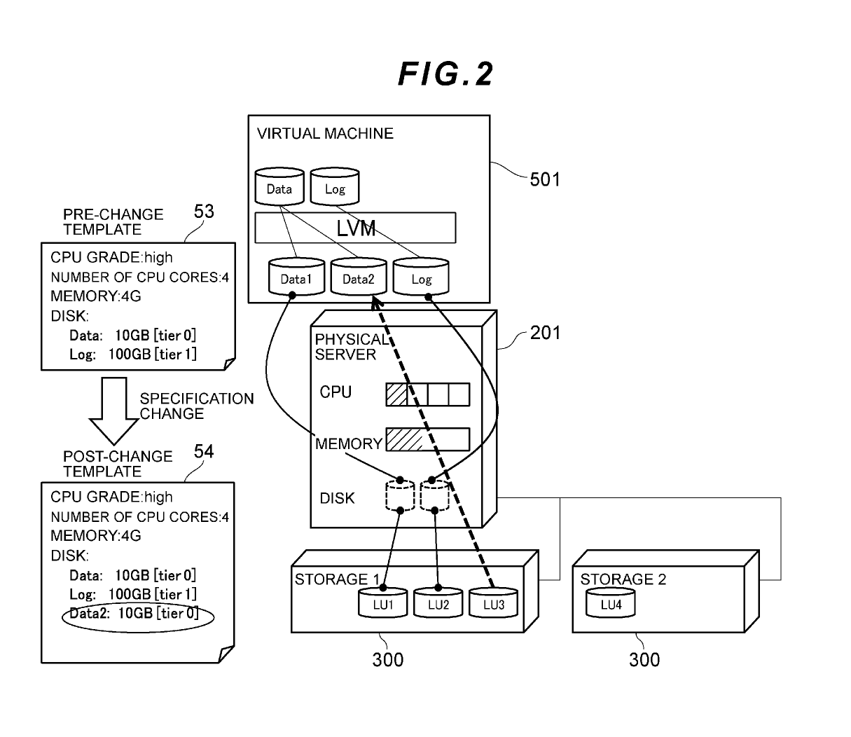

The outline of this embodiment will be explained with reference to FIG. 1 and FIG. 2. A computer system in recent years realizes a virtual machine technique that virtually divides physical resources of a server system by using software and constitutes a plurality of “virtual machines” on the server. This virtual machine technique can deploy a plurality of virtual machines on one physical server and have an OS operate independently on each virtual machine. In this embodiment, a virtual server system including, for example, this virtual machine and a storage apparatus is provided to a user and the operation (provisioning) is performed to construct or change the virtual server system in accordance with specifications requested by the user.

FIG. 1 shows a case where specifications of resources for a virtual server system are enhanced. A template 51 which shows settings of each resource is created in accordance with specifications requested by the user. Values of, for example, a CPU grade, the number of cores, a memory capacity, and a disk capacity are set to the template 51 as illustrated in FIG. 1. A virtual server system 500 that suits the user's request is constructed based on this template 51.

Moreover, when the settings of the resources for the virtual machine 501 are changed by, for example, changing the specifications of a business system, the virtual server system 500 is reconstructed and the settings of the resources are changed based on the changed template. For example, when changing the number of CPU cores from 4 to 8 and changing the memory capacity from 4 GB to 8 GB, a value of the number of CPU cores on the template 51 is changed from 4 to 8 and a value of the memory capacity is changed from 4 GB to 8 GB, thereby creating a template 52.

According to conventional technology, a software configuration required by the business system to which the resources are allocated is compared with a software configuration of a virtual server system which can be provided, in order to curb migration cost and the resources for the virtual server system are grouped in the order of the resources having closer configuration. Then, a virtual server system which should be newly allocated to the business system can be promptly found upon a request and a software environment that fulfills the request can be constructed.

However, when changing the software configuration of the virtual server system allocated to the business system, the above-described conventional technology has a problem of the necessity to always allocate a new virtual server system and migrate the system even in a case of a small-scale change. For example, if the request is satisfied by only changing the settings of the virtual server system, for example, when reducing the abilities of the resources such as a CPU, it is desirable that only the settings of the virtual server system should be changed without migration to minimize migration time and curb the cost.

So, when the content of the template is changed in this embodiment, a resource type to be added and an amount to be allocated are calculated based on the content of the change and a necessary resource is secured from a physical server or storage apparatus that can provide the amount to be allocated. When this happens, the necessary resource is secured so that the cost associated with the change of the system will be minimized based on the calculated resource type and amount to be allocated.

For example, when server resources such as a CPU or a memory are to be enhanced, whether a physical server which provides an allocated virtual server system still has an available resource capacity or not is judged. Moreover, when storage resources such as disks are to be enhanced, whether a storage apparatus which provides an allocated storage area still has an available resource capacity or not is judged. Then, if the allocated physical server or storage apparatus still has an available resource capacity, that resource is allocated. As a result, it is possible to allocate the resource of the relevant physical server or storage apparatus by changing the settings of the system without performing migration, and minimize the cost associated with the change of the system.

Specifically speaking, referring to FIG. 1, a change is performed to enhance the number of CPU cores from 4 to 8 and enhance the memory capacity from 4 GB to 8 GB. In this case, an unused resource of a physical server 201 which allocates a CPU and a memory to a virtual machine 501 is preferentially searched. If the physical server 201 which provides the virtual server system 500 has an unused resource, the resource is immediately allocated to the virtual machine 501 by using a specified command, so that the cost associated with the change of the system can be minimized. On the other hand, if the physical server 201 which provides the virtual server system 500 does not have an unused resource, all available physical servers 201 are searched for an unused resource and the resource is then allocated to the virtual machine 501.

Furthermore, referring to FIG. 2, a change is performed to expand the disk capacity by 10 GB. In this case, an unused disk capacity of the storage apparatus 300 which is already connected to the physical server 201 is preferentially searched. In this case as well, if the storage apparatus 300 which is already connected has an unused disk capacity, disks can be added without executing, for example, setting processing related to the connection to the storage apparatus 300, so that the cost associated with the change of the system can be minimized. Furthermore, data of one virtual server system 500 can be aggregated in one storage apparatus 300 by using an unused disk capacity of the storage apparatus 300 which is already connected. As a result, operation cost of the virtual server system 500 can be reduced by shortening data backup time.

Incidentally, of the resources provided to the virtual server system 500, resources such as a CPU, which are provided by the server computer 200 to the virtual server system 500, are called physical resources in descriptions below and the physical resources may sometimes be distinguished from a disk capacity provided by the storage apparatus 300 to the virtual server system 500.

### (1-2) Hardware Configuration

### (1-2-1) Configuration of Computer System

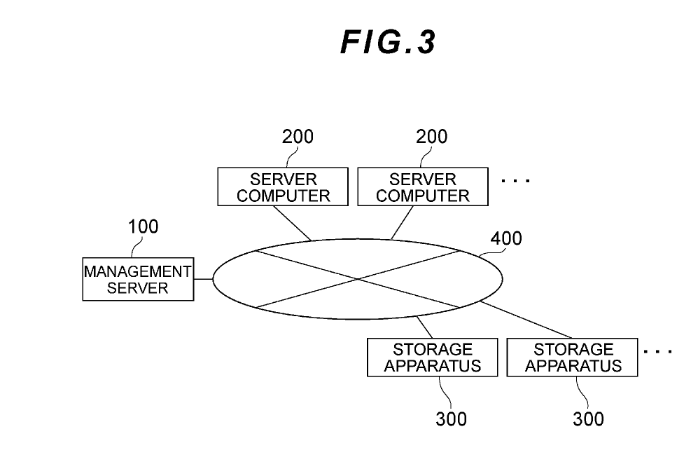

Next, a hardware configuration of a computer system according to this embodiment will be explained. As illustrated in FIG. 3, the computer system includes a management server 100, server computers 200, and storage apparatuses 300. The management server 100, the server computers 200, and the storage apparatuses 300 are connected via a network 400 such as a SAN (Storage Area Network) or a LAN (Local Area Network).

Regarding the server computer 200 and the storage apparatus 300, one server computer 200 or one storage apparatus 300 may be connected to the network 400 or a plurality of server computers 200 or storage apparatuses 300 may be connected to the network 400. Moreover, a client terminal (not shown in the drawing) used by a user who uses, for example, a business system may be connected to the network 400.

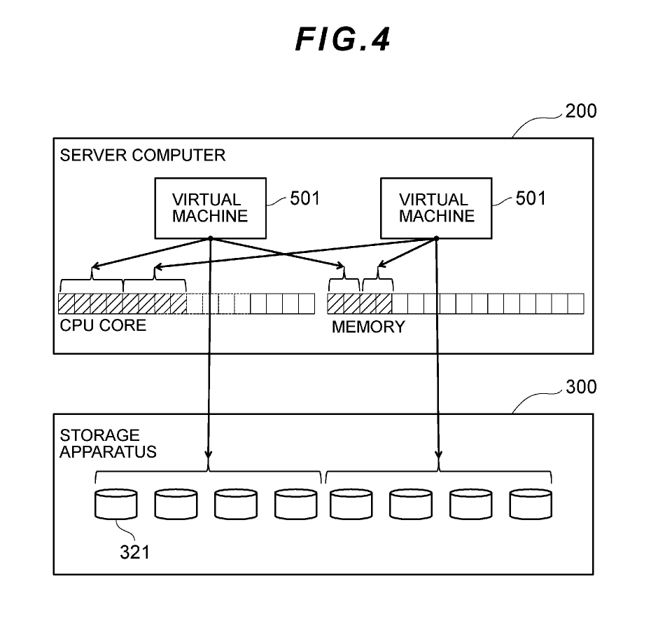

Furthermore, in this embodiment as illustrated in FIG. 4, physical computer resources (hereinafter sometimes referred to as the “resources”) of the server computer 200 are virtually divided and the virtually divided resources are allocated to a plurality of virtual machines 501 configured on the server computer 200. Moreover, the disk capacity of the storage apparatus 300 is also virtually divided like the resources of the server computer 200 and the virtually divided disk capacities are allocated to the virtual machines 501. The management server 100 is a device for managing the configuration of the virtual machines 501 and the resources of the server computers 200 and the storage apparatuses 300 to be allocated to the virtual machines 501.

### (1-2-2) Hardware Configuration of Management Server

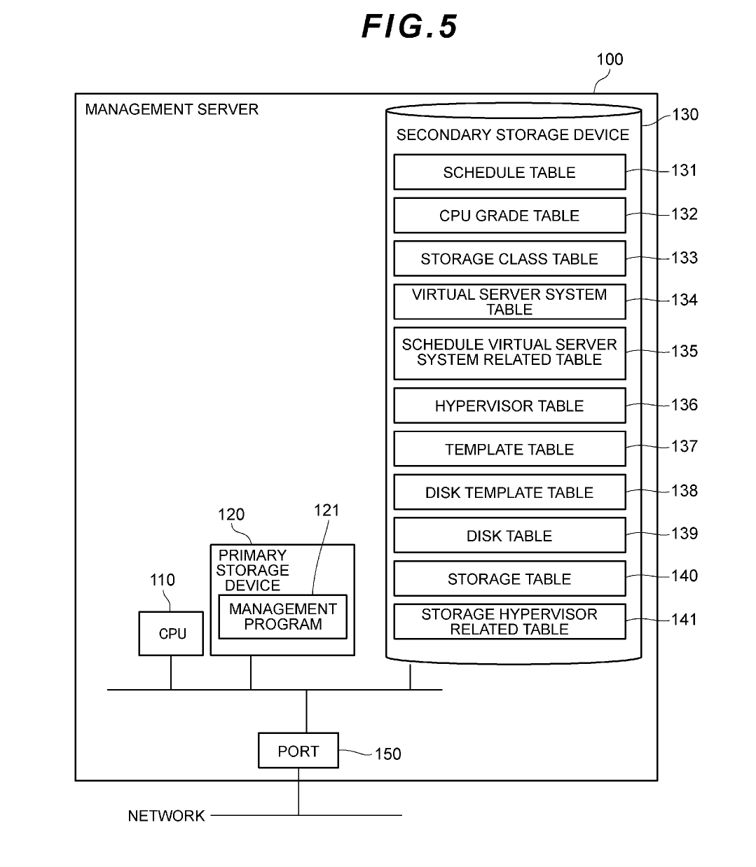

The management server 100 includes, for example, a CPU 110, a primary storage device 120, a secondary storage device 130, and a port 150 as illustrated in FIG. 5.

The CPU 110 functions as an arithmetic processing unit and a control device and controls the operation of the entire management server 100 in accordance with various programs stored in the primary storage device 120.

The primary storage device 120 stores, for example, programs and operation parameters used by the CPU 110 and is constituted from, for example, a ROM (Read Only Memory) or a RAM (Random Access Memory). The primary storage device 120 stores a management program 121 for managing the construction and changes of a virtual server system 500. The details of the operation of the management program 121 will be explained later.

The secondary storage device 130 is a data storage device configured as one example of a memory unit for the management server 100 and is constituted from, for example, a HDD (Hard Disk Drive). The HDD includes a plurality of storage media and may be constituted from a plurality of hard disk drives, for example, expensive hard disk drives such as SSDs (Solid State Disks) or SCSI (Small Computer System Interface) disks or inexpensive hard disk drives such as SATA (Serial AT Attachment) disks. The secondary storage device 130 activates hard disks and stores programs executed by the CPU 110 and various data.

The secondary storage device 130 stores, for example, a schedule table 131, a CPU grade table 132, a storage class table 133, a virtual server system table 134, a schedule virtual server system related table 135, a hypervisor table 136, a template table 137, a disk template table 138, a disk table 139, a storage table 140, and a storage hypervisor related table 141. The content of each table will be explained later in detail.

The port 150 is an interface connected to external equipment and is a connection port for connecting to external equipment which is capable of data transfer and is to be connected to, for example, a local area network (LAN).

Incidentally, the management server 100 includes an input/output device. Examples of the input/output device may be a display, a keyboard, and a pointer device, but may also include other devices. Moreover, instead of the input/output device, a serial interface or an Ethernet interface may be used as the input/output device; and a display computer having a display or keyboard or pointer device may be connected to the interface, display information may be sent to the display computer, and information for input may be received from the display computer, so that displaying the information on the display computer and accepting inputs to the display computer may be substituted for inputting and displaying of the information on the input/output device.

A set of one or more computers for managing the virtual server system 500 and displaying display information of the present invention may be hereinafter sometimes referred to as the “management system.” When the management server 100 displays the display information, the management server is the management system. Moreover, a combination of the management server 100 and the display computer is also the management system. Furthermore, a plurality of computers may be used to implement processing equivalent to that of the management server 100 in order to achieve high speed and high reliability of management processing. In this case, the plurality of computers (including the display computer if display is performed by the display computer) constitutes the management system.

### (1-2-3) Hardware Configuration of Server Computer

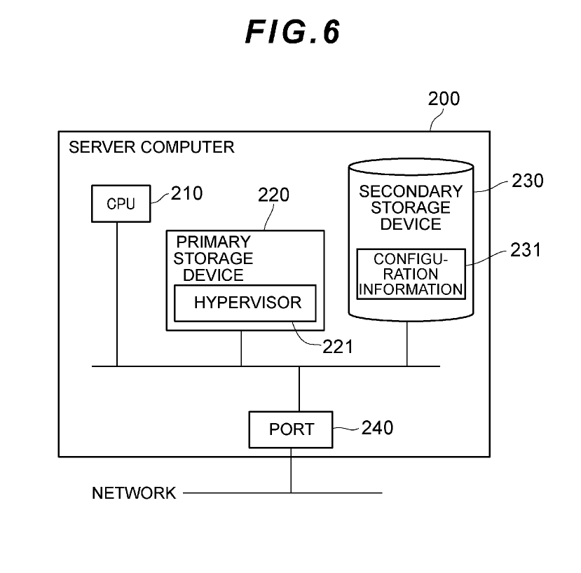

Furthermore, the server computer 200 includes a CPU 210, a primary storage device 220, a secondary storage device 230, and a port 240 as illustrated in FIG. 6.

The CPU 210 functions as an arithmetic processing unit and a control device and controls the operation of the entire server computer 200 in accordance with various programs stored in the primary storage device 220.

The primary storage device 220 stores, for example, programs and operation parameters used by the CPU 210 and is constituted from, for example, a ROM (Read Only Memory) or a RAM (Random Access Memory). The primary storage device 220 stores a hypervisor 221 for managing, for example, physical resources mounted in the server computer 200.

The secondary storage device 230 is a data storage device configured as one example of a memory unit for the management server 200 and is constituted from, for example, an HDD (Hard Disk Drive). The HDD includes a plurality of storage media and may be constituted from a plurality of hard disk drives, for example, expensive hard disk drives such as SSDs (Solid State Disks) or SCSI (Small Computer System Interface) disks or inexpensive hard disk drives such as SATA (Serial AT Attachment) disks. The secondary storage device 230 activates hard disks and stores programs executed by the CPU 210 and various data. The secondary storage device 230 stores configuration information 231 indicating the configuration of the physical resources mounted in the server computer 200.

The port 240 is an interface connected to external equipment and is a connection port for connecting to external equipment which is capable of data transfer by means of, for example, a USB (Universal Serial Bus).

### (1-2-4) Hardware Configuration of Storage Apparatus

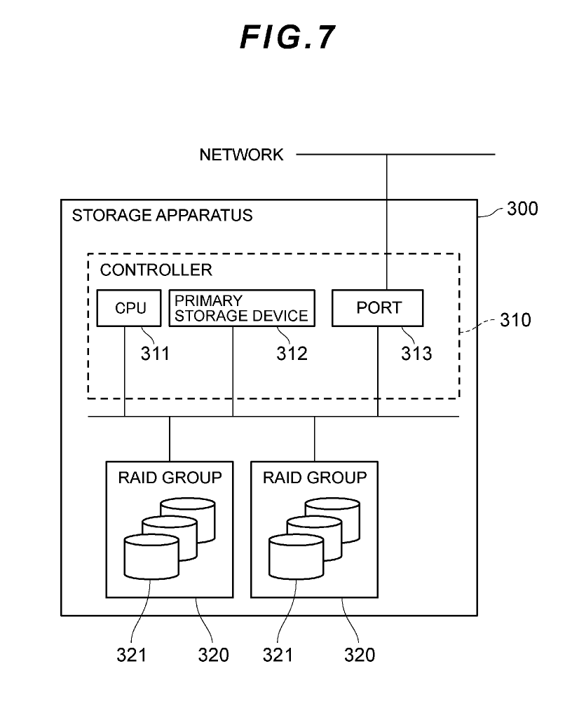

Furthermore, the storage apparatus 300 includes a controller 310, which is equipped with a CPU 311, a primary storage device 312, and a port 313, and disks 321 constituting RAID groups 320 as illustrated in FIG. 7.

The controller 310 has a function managing the disks 321 and the CPU 311, which serves as an arithmetic processing unit and control device, controls the operation of the entire storage apparatus 300 and writing of data to the disks 321 in accordance with various programs stored in the primary storage device 312. Moreover, the port 313 is an interface connected to external equipment and is an I/O port such as Fibre Channel or iSCSI for communications between the server and the storage apparatus.

The disks 321 are constituted from a plurality of storage media. For example, the disks 321 may be constituted from a plurality of hard disk drives, for example, expensive hard disk drives such as SSDs (Solid State Disk) or SCSI (Small Computer System Interface) disks or inexpensive hard disk drives such as SATA (Serial AT Attachment) disks.

Furthermore, a plurality of HDDs 104 constitutes one RAID (Redundant Array of Inexpensive Disks) group and one or more logical units (LUs) are set in physical storage areas provided by one or more RAID groups. Then, received data are stored in this logical unit (LU) in block units of a specified size.

With the storage apparatus 300 according to this embodiment, a RAID group is defined by one or more disks 321 of the same type (such as SSD, SAS, or SATA) and one or more pool volumes are defined in storage areas provided by one or more storage devices constituting one RAID group. Moreover, each pool volume defined in the storage areas provided by the storage devices of the same type is managed as a storage tier (Tier) of the same type and a plurality of pool volumes belonging to different storage tiers (Tiers) is managed as one pool.

Regarding the storage devices, three types of storage devices such as SSDs, SAS disks, and SATA disks are used; a pool volume defined in storage areas provided by one or more SSDs is managed as a storage tier called “Tier 1”; a pool volume defined in storage areas provided by one or more SAS disks is managed as a storage tier called “Tier 2”; and a pool volume defined in storage areas provided by one or more SATA disks is managed as a storage tier called “Tier 3.”

Incidentally, of these types (SSD, SAS, and SATA) of storage devices, those having the highest response performance are SSDs, those having the second highest response performance are SAS disks, and those having the lowest response performance are SATA disks. Therefore, of the three tiers constituting a pool volume in a case of this embodiment, a storage tier having the highest response performance is Tier 1, a storage tier having the second highest response performance is Tier 2, and a storage tier having the lowest response performance is Tier 3.

### (1-3) Various Tables

Next, various tables stored in the secondary storage device 130 of the management server 100 will be explained.

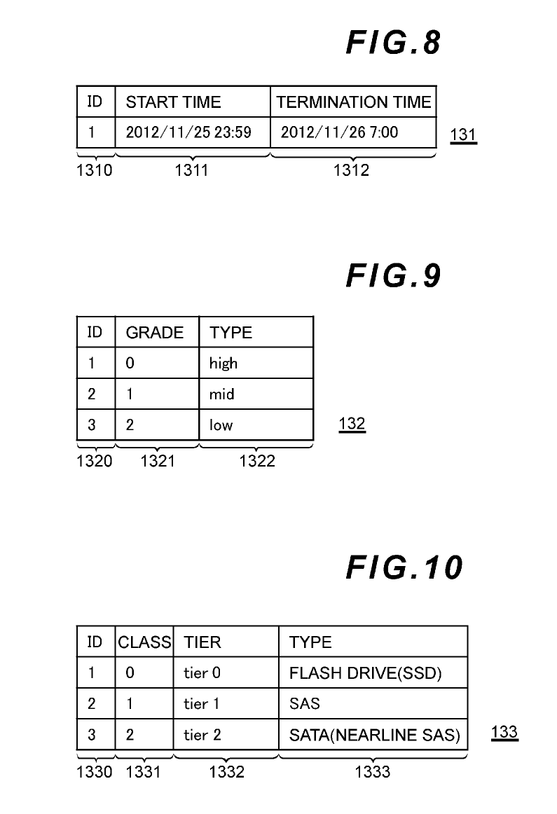

FIG. 8 is a chart showing the content of the schedule table 131. The schedule table 131 is a table for managing time when the migration processing is to be executed; and is constituted from an ID column 1310, a start time column 1311, and a termination time column 1312 as illustrated in FIG. 8.

The ID column 1310 stores information for identifying each entry of the schedule table 131. The start time column 1311 stores start time to execute the migration processing and the termination time column 1312 stores termination time to terminate the execution of the migration processing. When executing the migration processing in response to a change request, the management program 121 of the management server 100 registers, for example, the start time to execute the migration processing in the schedule table 131.

FIG. 9 is a chart showing the content of the CPU grade table 132. The CPU grade table 132 is a table showing the correspondence relationship between the grade of a CPU mounted in the server computer 200 and the type of the CPU; and is constituted from an ID column 1320, a grade column 1321, and a type column 1322 as illustrated from FIG. 9.

The ID column 1320 stores information for identifying each entry of the CPU grade table 132. The grade column 1321 stores information indicating the CPU grade. The type column 1322 stores information indicating the type of the CPU corresponding to the CPU grade. FIG. 9 shows that, for example, a CPU of grade 0 is a high-grade CPU (high); and similarly, a CPU of grade 1 is a middle-grade CPU (mid), and a CPU of grade 2 is a low-grade CPU (low). The information stored in the CPU grade table 132 is preset by an administrator of the management server 100.

FIG. 10 is a chart showing the content of the storage class table 133. The storage class table 133 is a table indicating the correspondence relationship between a storage class and a storage tier; and is constituted from an ID column 1330, a class column 1331, a tier column 1332, and a type column 1333 as illustrated in FIG. 10.

The ID column 1330 stores information for identifying each entry of the storage class table 133. The class column 1331 stores information for identifying a storage class. The tier column 1332 stores information for identifying a storage tier corresponding to the storage class. The type column 1333 stores information about the type of disks constituting each tier. FIG. 10 shows that, for example, a tier of storage class 0 is a high-grade tier (Tier 0) and is constituted from flash drives such as SSDs. Similarly, a tier of storage class 1 is a middle-grade tier (Tier 1) and is constituted from SAS (Serial Attached SCSI) disks; and a tier of storage class 2 is a low-grade tier (Tier 2) and is constituted from SATA (nearline SAS) disks. The information stored in the storage class table 133 is preset by the administrator of the management server 100.

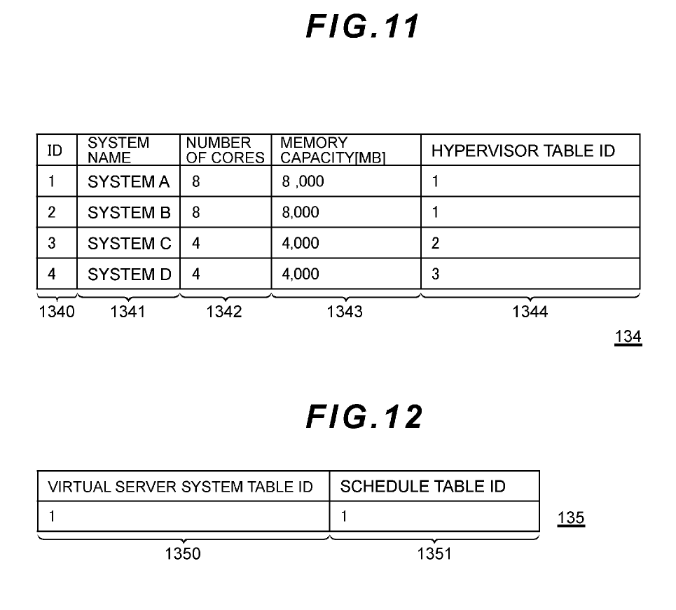

FIG. 11 is a chart showing the content of the virtual server system table 134. The virtual server system table 134 is a table for managing configuration information of the virtual server system 500; and is constituted from an ID column 1340, a system name column 1341, a number-of-cores column 1342, a memory capacity column 1343, and a hypervisor table ID column 1344 as illustrated in FIG. 11.

The ID column 1340 stores information for identifying each entry of the virtual server system table 134. The system name column 1341 stores system name information about a virtual server system. The number-of-cores column 1342 stores information about the number of CPU cores that are set to each virtual server system 500. The memory capacity column 1343 stores information about a memory capacity that is set to each virtual server system 500. The hypervisor table ID column 1344 stores information for identifying the relevant entry of a hypervisor table for managing a hypervisor 221 that is set to each virtual server system 500. FIG. 11 shows that, for example, regarding System A of the virtual server system 500, the number of mounted CPU cores is 8 and the mounted memory capacity is 8000 MB, and the hypervisor table ID is 1. The hypervisor table 136 will be explained later in detail.

FIG. 12 is a chart showing the content of the schedule virtual server system related table 135. The virtual server system schedule table 135 is a table for managing the correspondence relationship between each virtual server system and a schedule table; and is constituted from a virtual server system table ID column 1350 and a schedule table ID column 1351 as illustrated in FIG. 12.

The virtual server system table ID column 1350 stores information for identifying the relevant entry of the virtual server system table 134. The schedule table ID column 1351 stores information for identifying the relevant entry of the schedule table 131.

FIG. 12 shows that, for example, with System A whose entry ID of the virtual server system table 134 is 1, migration will be executed according to a schedule whose entry ID of the schedule table 131 is 1.

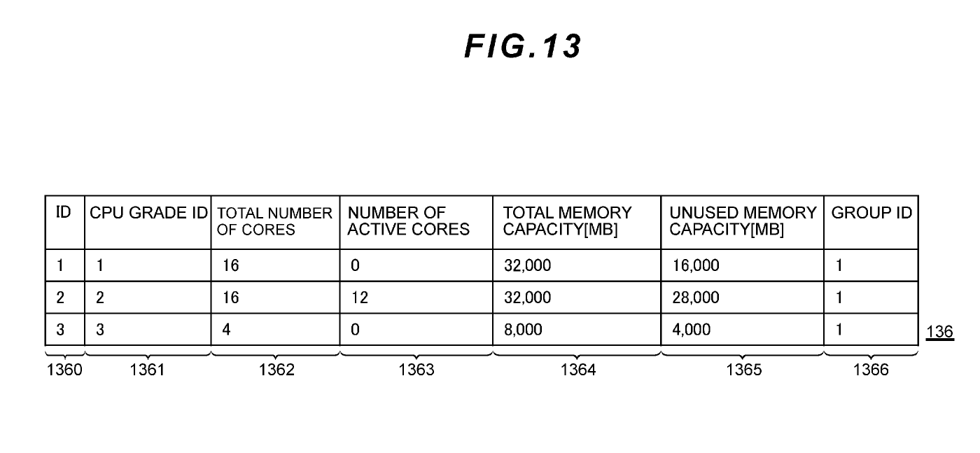

FIG. 13 is a chart showing the content of the hypervisor table 136. The hypervisor table 136 is a table for managing configuration information of the hypervisor 221 which manages the physical resources mounted in the computer server 200; and is constituted from an ID column 1360, a CPU grade ID column 1361, a total-number-of-cores column 1362, a number-of-active-cores column 1363, a total memory capacity 1364, an unused memory capacity column 1365, and a group ID column 1366 as illustrated in FIG. 13.

The ID column 1360 stores information for identifying the relevant entry of the hypervisor table 136. The CPU grade ID column 1361 stores identification information of the CPU grade, that is, a value of the CPU grade stored in the grade column 1321 of the CPU grade table 132. The total-number-of-cores column 1362 stores the total number of cores of the CPU managed by the relevant hypervisor 221 and the number-of-active-cores column 1363 stores the number of active cores. The total memory capacity column 1364 stores a memory capacity managed by the relevant hypervisor 221 and the unused memory capacity column stores an unused memory capacity. Moreover, the group ID column 1366 stores information for identifying a group to which the hypervisor 221 belongs.

FIG. 13 shows that, for example, the CPU grade ID of the hypervisor 221 whose identification information is 1 is 1, that is, a middle grade, the total number of cores is 16, the number of active cores is 0, the total memory capacity is 32,000 MB, the unused memory capacity is 16,000 MB, and the group ID is 1.

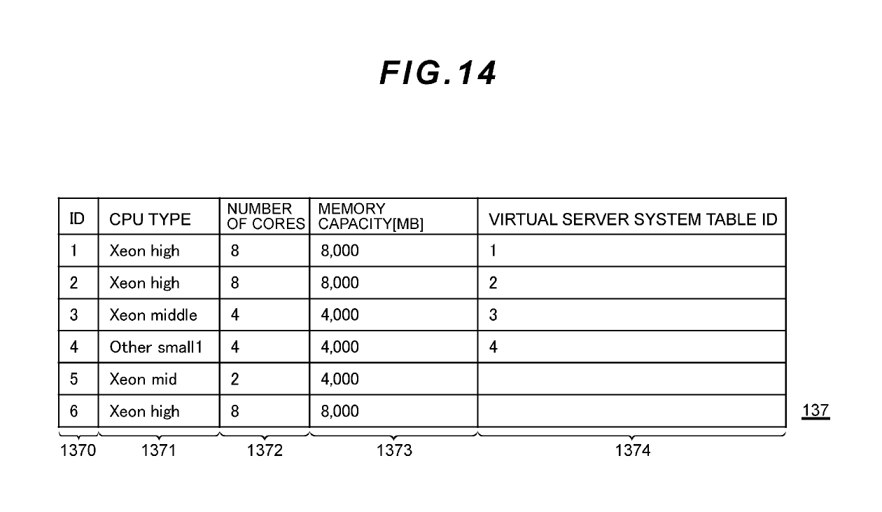

FIG. 14 is a chart showing the content of the template table 137. The template table 137 is a template showing the setting content of a virtual server system 500 according to specifications requested by the user; and is constituted from an ID column 1370, a CPU type column 1371, a number-of-cores column 1372, a memory capacity column 1373, and a virtual server system table ID column 1374.

The ID column 1370 stores information for identifying the relevant entry of the template table 137. The CPU type column 1371 stores information for identifying the requested CPU type. The number-of-cores column 1372 stores the requested number of CPU cores. The memory capacity column 1373 stores the requested memory capacity. The virtual server system table ID column 1374 stores information for identifying the relevant entry of the virtual server system table 134 corresponding to a virtual server system constructed according to the request content.

FIG. 14 shows that, for example, if the user requests that the CPU type should be Xeon high, the number of cores should be 8, and the memory capacity should be 8000 MB, System A whose identification information of the virtual server system table 134 is 1 is constructed.

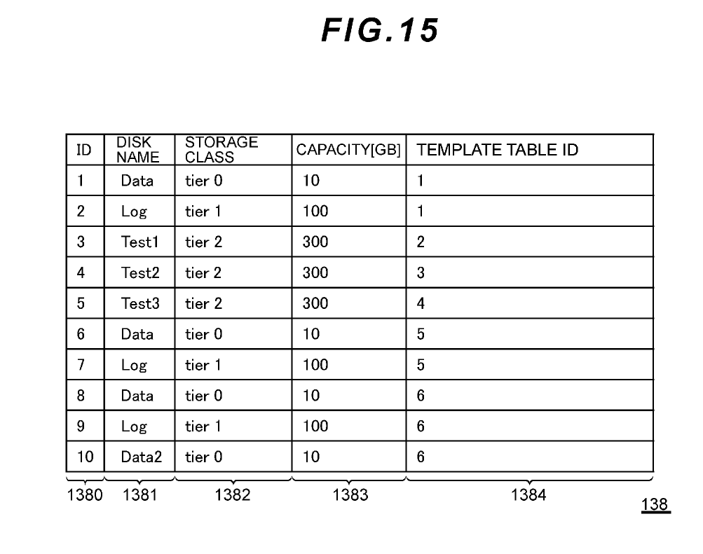

FIG. 15 is a chart showing the content of the disk template table 138. The disk template table 138 is a template showing the setting content of a storage apparatus 300 according to specifications request by the user; and is constituted from an ID column 1380, a name column 1381, a storage class 1382, a capacity column 1383, and a template table ID column 1384.

The ID column 1380 stores information for identifying the relevant entry of the disk template table 138. The name column 1381 stores the name of the relevant disk. The storage class 1382 stores the type of a storage tier which stores data; and the capacity column 1383 stores information about the requested storage capacity. The template table ID column 1384 stores information for identifying the relevant entry of the template table 137 corresponding to the relevant disk template.

FIG. 15 shows that, for example, a disk selected in response to the user's request is a disk whose name is Data, the storage class is Tier 0, the storage capacity is 10 GB, and the ID of the relevant template table 137 is 1.

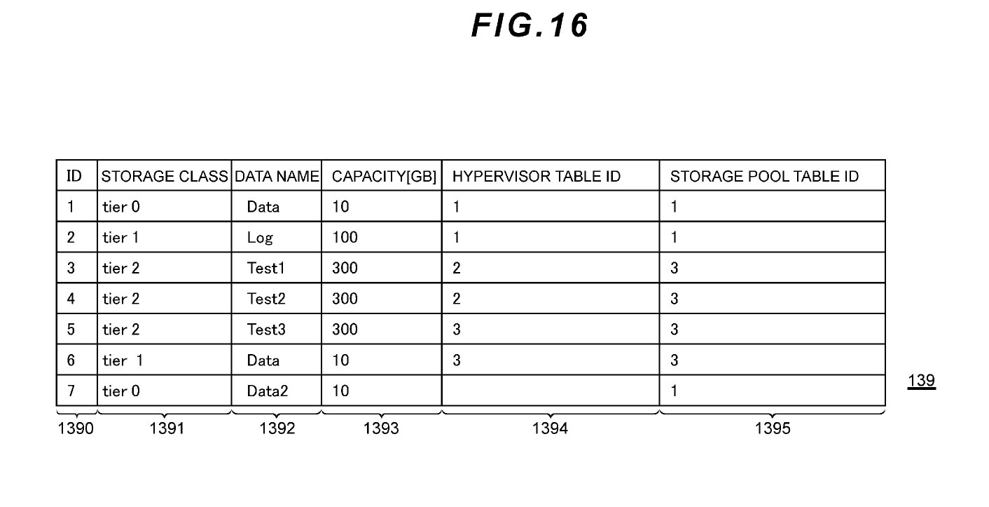

FIG. 16 is a chart showing the content of the disk table 139. The disk table 139 is a table for managing the disks 321 of the storage apparatus 300; and is constituted from an ID column 1390, a storage class column 1391, a disk name column 1392, a capacity column 1393, a hypervisor table ID column 1394, and a storage pool table ID column 1395 as illustrated in FIG. 16.

The ID column 1390 stores information for identifying each entry of the disk table 139. The storage class column 1391 stores the type of the relevant storage tier. The disk name column 1392 stores the name of the relevant disk. The capacity column 1393 stores the storage capacity of each disk 321. The hypervisor table ID column 1394 stores information for identifying the hypervisor 221 which manages the disk 321. The storage pool table ID column 1395 stores information for identifying a storage pool to which each disk 321 belongs.

FIG. 16 shows that, for example, the disk Data of the high-grade storage tier Tier 0 has a storage capacity of 10 GB, the ID of the hypervisor table which manages that disk is 1, and a storage pool to which that disk belongs is 1.

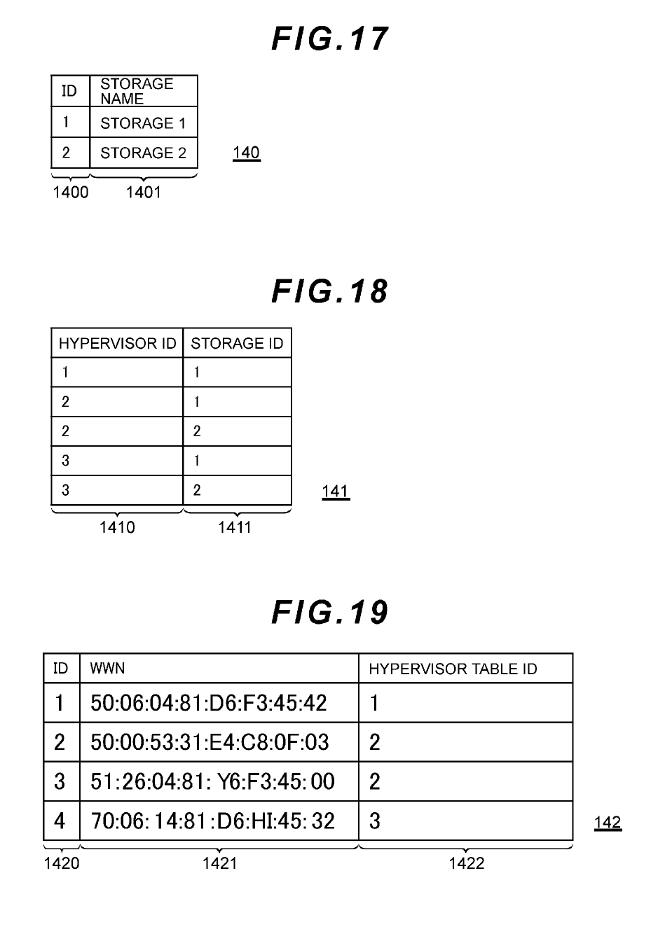

FIG. 17 is a chart showing the content of the storage table 140. The storage table 140 is a table for managing storage apparatuses 300; and is constituted from an ID column 1400 and a storage name column 1401.

The ID column 1400 stores information for identifying the relevant entry of the storage table 140. The storage name column 1401 stores a storage name. FIG. 17 shows that the name of a storage apparatus identified with identification information 1 is Storage 1.

FIG. 18 is a chart showing the content of the storage-hypervisor related table 141. The storage-hypervisor related table 141 is a table indicating the correspondence relationship between hypervisors 221 and storage apparatuses 300; and is constituted from a hypervisor ID column 1410 and a storage ID column 1411.

The hypervisor ID column 1410 stores information for identifying the relevant hypervisor 221. The storage ID column 1411 stores information for identifying the relevant storage apparatus 300. FIG. 18 shows that the hypervisor 221 identified with the identification information 1 corresponds to the storage apparatus 300 identified with the identification information 1.

FIG. 19 is a chart showing the content of the server port table 142. The server port table 142 is a table for managing ports 240 of the server computer 200; and is constituted from an ID column 1420, a WWN column 1421, and a hypervisor table ID column 1422 as illustrated from FIG. 19.

The ID column 1420 stores information for identifying the relevant entry of the server port table 142. The WWN column 1421 stores information about a WWN of the relevant port 240 of the server computer 200. The hypervisor table ID column 1422 stores information for identifying the hypervisor 221 corresponding to the port 240. FIG. 19 shows that, for example, a port 240 whose WWN is 50:06:04:81:D6:F3:45:42 corresponds to a hypervisor 221 which is identified with the identification information 1.

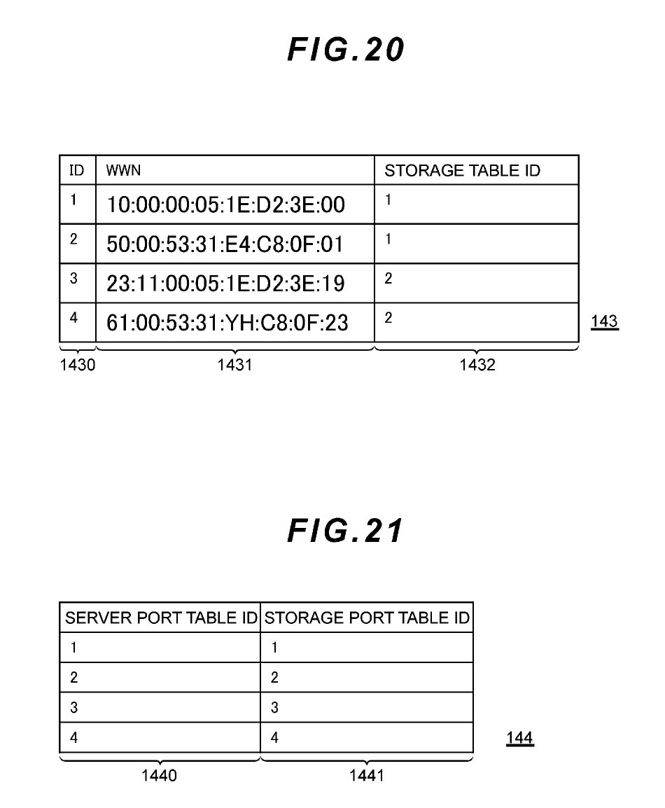

FIG. 20 is a chart showing the content of the storage port table 143. The storage port table 143 is a table for managing ports 313 of storage apparatuses 300; and is constituted from an ID column 1430, a WWN column 1431, and a storage table ID column 1432 as illustrated in FIG. 20.

The ID column 1430 stores information for identifying the relevant entry of the storage port table 143. The WWN column 1431 stores information about a WWN of the relevant port 313 of the storage apparatus 300. The storage table ID column 1432 stores information for identifying a storage apparatus 300 corresponding to the relevant port 313. FIG. 20 shows that, for example, a port 313 whose WWN is 10:00:00:05:1 E:D2:3E:00 corresponds to a storage apparatus 300 which is identified with the identification information 1.

FIG. 21 is a chart showing the content of the server port-storage port related table 144. The server port-storage port related table 144 is a table for managing the correspondence relationship between server ports and storage ports; and is constituted from a server port table ID column 1440 and a storage port table ID column 1441 as illustrated in FIG. 21.

The server port table ID column 1440 stores information for identifying the relevant entry of the server port table 142. The storage port table ID column 1441 stores information for identifying the relevant entry of the storage port table 143. FIG. 21 shows that, for example, a port 240 of the server computer 200 which is indicated in the server port table 142 identified with the identification information 1 corresponds to a port 313 of the storage apparatus 300 which is indicated in the storage port table 143 identified with the identification information 1.

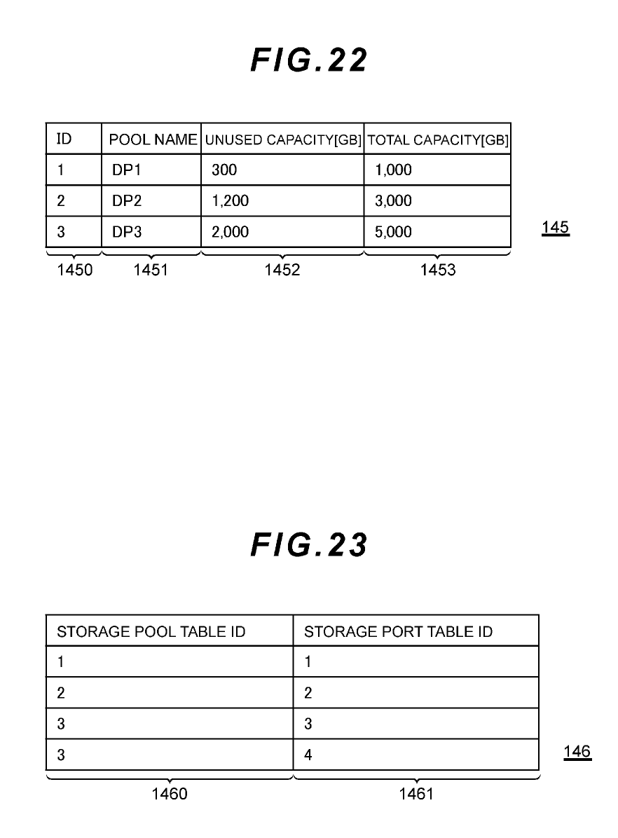

FIG. 22 is a chart showing the content of the storage pool table 145. The storage pool table 145 is a table for managing the configuration of a storage pool constituted from one or more disks 321; and the storage pool table 145 is constituted from an ID column 1450, a pool name column 1451, an unused capacity column 1452, and a total capacity column 1453 as illustrated in FIG. 22.

The ID column 1450 stores information for identifying the relevant entry of the storage pool table 145. The pool name column 1451 stores the name of the relevant storage pool. The unused capacity column 1452 stores an unused capacity of the storage pool. The total capacity column 1453 stores the total capacity of the storage pool. FIG. 22 shows that, for example, the unused capacity of a storage pool whose name is DP1 is 300 GB and its total capacity is 1,000 GB.

FIG. 23 is a chart showing the content of the storage pool-storage port related table 146. The storage pool-storage port related table 146 is a table for managing the correspondence relationship between storage pools and storage ports; and is constituted from a storage pool table ID column 1460 and a storage port table ID column 1461 as illustrated in FIG. 23.

The storage pool table ID column 1460 stores information for identifying the relevant entry of the storage pool table 145. The storage port table ID column 1461 stores information for identifying the relevant entry of the storage port table 143. FIG. 23 shows that, for example, the storage pool indicated in the storage pool table 145 which is identified with the identification information 1 corresponds to the port 313 of the storage apparatus 300 indicated in the storage port table 143 which is identified with the identification information 1.

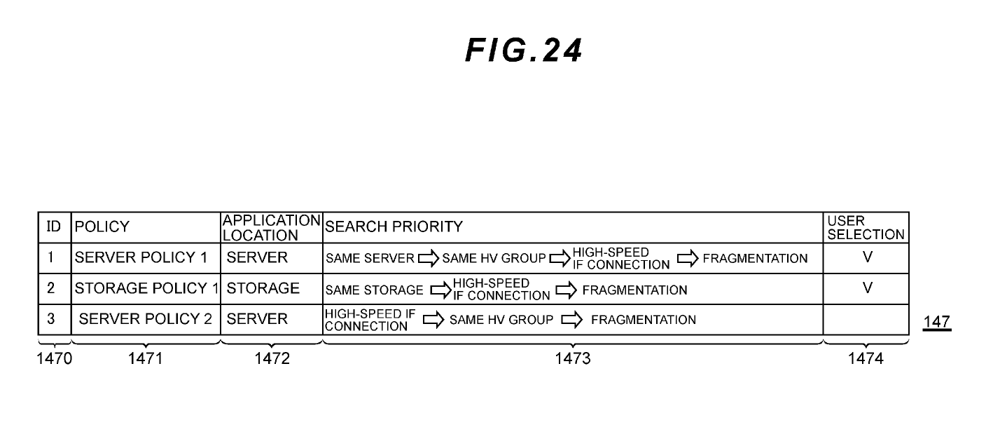

FIG. 24 is a chart showing the content of the search policy table 147. The search policy table 147 is a table for managing a search policy when searching for an unused resource or an unused disk; and is constituted from an ID column 1470, a policy column 1471, an application location column 1472, a search priority column 1473, and a user selection column 1474 as illustrated in FIG. 24.

The ID column 1470 stores information for identifying the relevant entry of the search policy table 147. The policy column 1471 stores the name of the relevant policy. The application location column 1472 stores information indicating an application location of each policy, for example, information indicating whether the relevant policy is for the server computer 200 or for the storage apparatus 300. The search priority column 1473 stores information indicating the order in which the unused resource or the unused disk is searched. The user selection column 1474 stores information indicating whether each policy is selected by the user or not.

FIG. 24 shows that, for example, a server policy 1 and a storage policy 1 are selected by the user. It is shown that the application location of the server policy 1 is the server computer 200 and the search priority is in the order of the same server, the same hypervisor group, high-speed interface connection, and fragmentation. It is also shown that the application location of the storage policy 1 is the storage apparatus 300 and the search priority is in the order of the same storage, high-speed interface connection, and fragmentation.

When the management program 121 of the management server 100 receives a request from the user to enhance the resources and the disks, it refers to the search policy table 147 and searches for a resource or disk in accordance with the search priority selected by the user in advance.

The same server or the same storage under this circumstance means to preferentially search for an unused disk of the storage apparatus 300 which provides resources and disks of the server computer 200 providing the resources allocated to the virtual server system 500 when enhancing the resources and disks. Moreover, the same hypervisor group means to preferentially search for a resource of a server computer 200 of the same hypervisor group as that of the server computer 200 which provides the resources allocated to the virtual server system 500. Furthermore, the high-speed interface connection means to preferentially search connected devices, which enable data transfer at high speeds, for a resource or disk. Also, the fragmentation means division of, for example, storage areas into small pieces; however, the fragmentation mentioned in relation to the search priority means to preferentially search for a resource or disk where a storage area can be secured so that the occurrence of the fragmentation will be avoided.

Accordingly, the user's request can be fulfilled by the system change without executing the migration processing by preferentially searching for an unused resource or unused disk of the server computer 200 or the storage apparatus 300 which provides the resources or the disks and, therefore, cost associated with the system change request can be reduced. Furthermore, even if there is no unused resource or unused disk in the same device as the device which provides the resources and disks to the virtual server system 500, a server computer 200 of the same hypervisor group or a server computer 200 or storage apparatus 300 which is connected via the high-speed interface connection is preferentially selected. As a result, a device capable of changing the system by reducing the migration time and cost can be set as a search target.

### (1-4) Details of Various Processing

Next, a processing sequence for various processing executed by the management program 121 of the management server 100 will be explained. The management program 121 constructs a virtual server system 500 in response to the user's request. Then, if the user makes a resource enhancement request or a disk addition request, the management program 121 changes various settings of the virtual server system 500 in accordance with specifications requested by the user. Moreover, if the specifications requested by the user cannot be fulfilled by just changing the settings of the virtual server system 500, the management program 121 executes migration processing.

### (1-4-1) New Allocation Processing

Firstly, processing for newly allocating a virtual machine 501 when constructing the virtual server system 500 in response to the user's request will be explained.

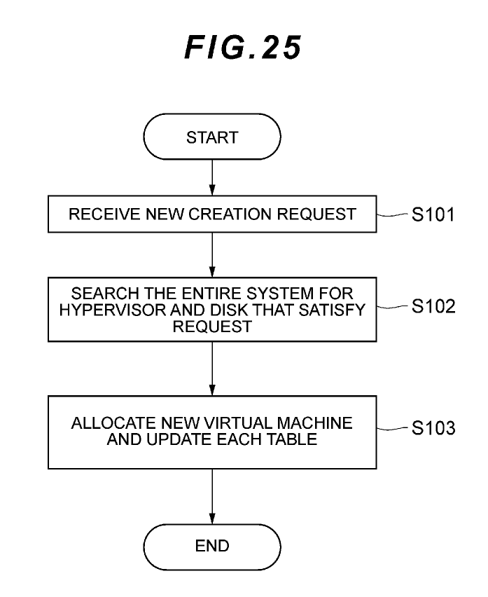

The management program 121 receives a request to create a new virtual machine 501 as input by the user as illustrated in FIG. 25 (S101). The user's input in step S101 is setting information about resources and disks. For example, the resource setting information includes a CPU grade, the number of cores, and a memory capacity; and the respective pieces of information are set by setting, for example, the CPU grade as high, the number of cores as 8, and the memory capacity as 8000 MB. Moreover, examples of the disk setting information include a storage capacity and a storage tier; and the disk setting information is set by setting, for example, the data storage capacity as 10 GB, the storage tier as Tier 0, a log storage capacity as 100 GB, and the storage tier as Tier 1.

The management program 121 which received the new creation request to create a new virtual machine 501 in step S101 searches the entire system, which is capable of creating the virtual machine 501, for a hypervisor 221 and disk 321 which satisfy the user's request (S102). Specifically speaking, the management program 121 refers to the hypervisor table 136 and the disk table 139 and searches for a hypervisor 221 having the CPU grade, the number of cores, and the unused memory capacity which satisfy the user's request, or a disk having the capacity and the storage tier which satisfy the user's request.

Then, the management program 121 allocates a new virtual machine 501 to the virtual server system 500 and updates the template table 137, the disk template table 138, the virtual server system table 134, and the disk table 139 (S103). Specifically speaking, the management program 121 stores the resource or disk setting information, which was requested for the template table 137 and the disk template table 138 by the user, in the template table 137 and the disk template table 138. The management program 121 also stores a system name and setting information of the newly created virtual server system 500 in the virtual server system table 134. Moreover, regarding the disk table 139, the management program 121 updates the disk capacity of the disk allocated to the virtual machine 501.

### (1-4-2) Configuration Information Collection Processing

Next, configuration information collection processing executed by the management program 121 will be explained. The configuration information collection processing is processing for acquiring the configuration information about the server computers 200 and the storage apparatuses 300 under control of the management program 121 before the above-mentioned processing for allocating a new virtual machine 501, processing for updating the virtual server system 500 as described later, or migration processing. Moreover, the configuration information collection processing may be executed periodically (for example, once every 15 minutes).

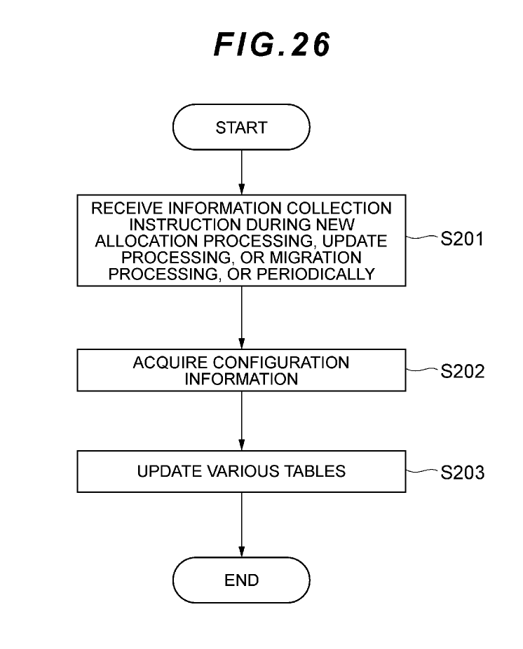

The management program 121 receives an information collection instruction at the time of execution of the new allocation processing, the update processing, or the migration processing or periodically as illustrated in FIG. 26 (S201).

The management program 121 accesses the hypervisors 221 of the server computers 200 and the storage apparatuses 300, which it manages, and acquires the configuration information about the resources and disks (S202).

Then, the management program 121 updates various tables based on the configuration information acquired in step S202 (S203). Specifically speaking, the management program 121 creates or updates the CPU grade table 132 and the storage class table 133. The management program 121 also updates the hypervisor table 136 and the disk table 139. Moreover, the management program 121 updates the storage table 140 and the storage hypervisor related table. Furthermore, the management program 121 updates the server port table 142, the storage port table 143, and the server port-storage port related table 144. The management program 121 also updates the storage pool table 145 and the storage pool-storage port related table 146.

### (1-4-3) System Update Processing

Next, the update processing executed by the management program 121 in response to the user's update request will be explained.

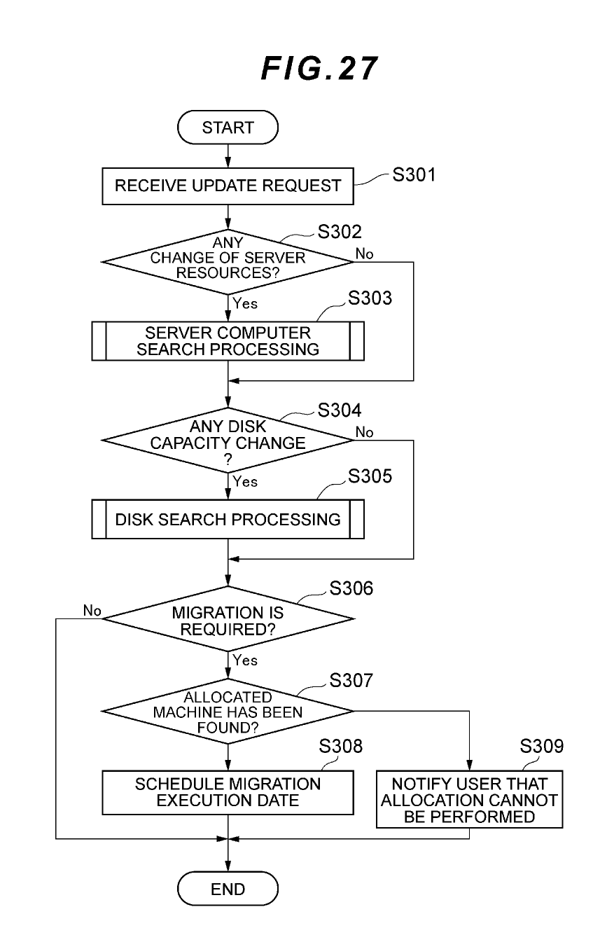

The management program 121 firstly receives a system change update request, which is input by the user, as illustrated in FIG. 27 (S301). Then, the management program 121 judges whether the update request received in step S301 includes a server resource change request or not. The server resource change means a change of, for example, the CPU grade, the number of CPU cores, or the memory capacity.

If it is determined in step S302 that the update request includes the server resource change request, the management program 121 executes computer server search processing (S303). On the other hand, if it is determined in step S302 that the update request does not include the server resource change request, the management program 121 executes processing in step S304 and subsequent steps.

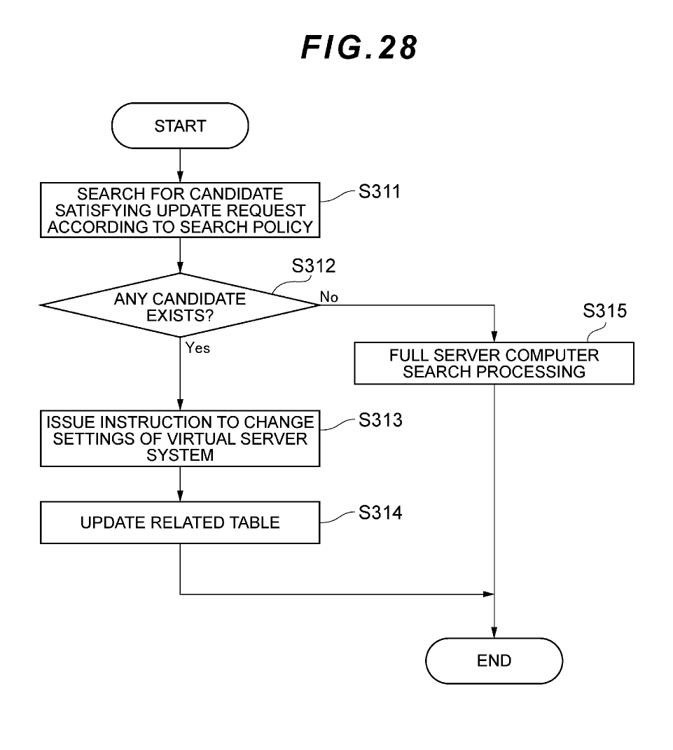

The details of the computer server search processing will be explained with reference to FIG. 28. Let us assume that the update request about the server resources, which was received in step S301 of FIG. 27, was made to request that, for example, the CPU grade should be a middle grade, the number of cores should be 2, and the memory capacity should be 4000 MB.

The management program 121 searches for a candidate, which satisfies the update request received in step S301, according to a search policy (S311). Specifically speaking, the management program 121 refers to the search policy table 147, selects a policy for which a selection flag is set to the user selection column 1474, from among policies whose application location is the server, and then acquires priority for a search method.

For example, with the search policy table 147 in FIG. 24, server policy 1 is selected among the server policy 1 and server policy 2 whose application location is the server, so that the search priority would be the same server, the same hypervisor (which is indicated as HV in the drawing), the high-speed interface (which is indicated as IF in the drawing), and the fragmentation.

Therefore, the management program 121 firstly preferentially searches for a resource of the server computer 200 which provides the resources of the virtual server system 500, for which the change request was made. The resource of the server computer 200 is searched by referring to the hypervisor table 136 and checking the CPU grade, the number of unused cores, and the unused memory capacity of a hypervisor 221 corresponding to the server computer which is a search target. Let us assume that the storage ID of the virtual server system 500 which is a target to be updated is 1 and the hypervisor ID of the corresponding hypervisor 221 is 1. In this case, the update request is made to request that the CPU grade should be a middle grade, the number of cores should be 2, and the memory capacity should be 4000 MB. So, you can tell by referring to the hypervisor table 136 that the CPU grade of the hypervisor 221 whose hypervisor ID is 1 is a middle grade, the number of unused cores is 16, and the unused memory capacity is 16,000 MB; and this hypervisor 221 satisfies the update request.

Moreover, if the resource of the same server computer 200 does not satisfy the change request, the management program 121 then searches for a resource of the hypervisor 221 with the same group ID. If the resource of the hypervisor 221 with the same group ID does not satisfy the change request, the management program 121 then searches for a resource of a server computer 200 capable of high-speed interface connection. Furthermore, if the resource of the server computer 200 capable of the high-speed interface connection cannot satisfy the change request, the management program 121 then searches for a server computer 200 which has a resource having a high fragmentation effect.

Then, as a result of the search according to the search policy by the above-described method, the management program 121 judges whether or not there is any candidate for the server computer 200 providing the resource which satisfies the change request (S312).

If it is determined in step S312 that there is a candidate for the server computer 200 which satisfies the change request, the management program 121 issues an instruction to the server computer 200 to change the settings of the virtual server system 500 (S313). Specifically speaking, the management program 121 provides the virtual server system 500 by using, for example, reallocation of the resources or live migration by the hypervisor 221. The management program 121 issues the instruction to the hypervisor 221 of the same server computers 200 as the server computer 200 to reallocate the resources and issues the instruction to the hypervisor 221 of the server computer 200, whose hypervisor is of the same group, to perform love migration.

Then, the management program 121 updates various tables related to the setting change of the virtual server system 500 in step S313 (S314). Specifically speaking, the management program 121 updates the newly allocated resource amount in the hypervisor table 136 and updates the values of the template table 137.

On the other hand, if it is determined as a result of the search according to the search policy in step S312 that there is no candidate for the server computer 200 which satisfies the change request, the management program 121 executes the search processing on all the server computers 200 (S315). Specifically speaking, the management program 121 searches all the entries of the hypervisor table 136 for a hypervisor 221 that satisfies the CPU grade, the number of unused CPU cores, and the unused memory capacity.

The details of the computer server search processing have been explained. Referring back to FIG. 27, the management program 121 judges whether the update request received in step S301 includes a disk capacity change request or not, in step S304.

If it is determined in step S304 that the update request includes the disk capacity change request, the management program 121 executes disk search processing (S305). On the other hand, if it is determined in step S305 that the update request does not include the disk capacity change request, the management program 121 terminates the update processing.

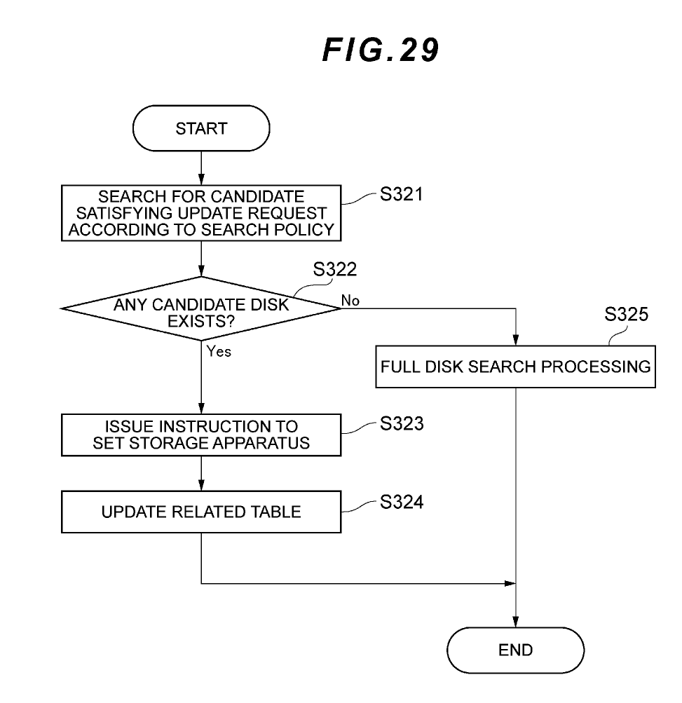

The details of the disk search processing will be explained with reference to FIG. 29. For example, let us assume that the change request about the disk capacity, which was received in step S301 of FIG. 27, was made to request that, for example, the data name should be Data 2, the additional capacity should be 10 GB, and the storage tier should be a high-grade tier (Tier 0).

The management program 121 searches for a candidate, which satisfies the update request received in step S301, according to a search policy (S321). Specifically speaking, the management program 121 refers to the search policy table 147, selects a policy for which a selection flag is set to the user selection column 1474, from among policies whose application location is the storage, and then acquires search method priority.

For example, with the search policy table 147 in FIG. 24, storage policy 1 whose application location is the storage is selected, so that the search priority would be the same storage, the high-speed interface, and the fragmentation.

Therefore, the management program 121 firstly preferentially searches for a disk of the storage apparatus 300 which provides the disks of the virtual server system 500, for which the change request was made. The disk of the storage apparatus 300 is searched by referring to the storage hypervisor related table 141, searching for a storage apparatus 300 corresponding to the hypervisor 221 which provides the resources of the virtual server system 500, and searching for an unused disk of the relevant storage apparatus 300. Moreover, if the unused disk of the same storage apparatus 300 as the storage apparatus 300 which provides the disks of the virtual server system 500 does not satisfy the change request, the management program 121 then searches for a disk of a storage apparatus 300 capable of high-speed interface connection. Furthermore, even if the resource of the storage apparatus 300 capable of the high-speed interface connection cannot satisfy the change request, the management program 121 then searches for a storage apparatus 300 which has a resource having a high fragmentation effect.

Then, as a result of the search according to the search policy by the above-described method, the management program 121 judges whether or not there is any candidate for the storage apparatus 300 providing the resource which satisfies the change request (S332).

If it is determined in step S322 that there is a candidate for the storage apparatus 300 which satisfies the change request, the management program 121 issues an instruction to the storage apparatus 300 to change the settings of the disk (S323). Specifically speaking, the management program 121 issues an instruction to the storage apparatus 300 to change the settings of the storage apparatus 300 so that the corresponding hypervisor 221 can recognize the disk which satisfies the change request.

Then, the management program 121 updates various tables related to the setting change of the storage apparatus 300 in step S323 (S324). Specifically speaking, the management program 121 stores the relevant hypervisor table ID in the hypervisor table ID column 1394 of an entry corresponding to the then allocated disk among entries of the disk table 139. The management program 121 also updates values of the disk template table 138.

On the other hand, if it is determined as a result of the search according to the search policy in step S322 that there is no candidate for the storage apparatus 300 which satisfies the change request, the management program 121 executes the search processing on all the storage apparatuses 300 (S325). Specifically speaking, the management program 121 searches all the entries of the disk table 139 for a disk that satisfies the requested disk capacity.

The details of the disk search processing have been explained. Referring back to FIG. 27, the management program 121 judges whether the migration processing is necessary or not (S306). Specifically speaking, the management program 121 cannot find a candidate by the server computer search processing and the disk search processing described above and the change request cannot be satisfied by only the system change processing, the management program 121 judges whether the migration processing is necessary or not.

If it is determined in step S306 that the migration processing is necessary, the management program 121 judges whether or not an allocated machine (the server computer 200 or the storage apparatus 300) to be allocated to the virtual server system 500 has been found by the full server computer search processing in step S315 or the full disk search processing in step S325 (S307).

If it is determined in step S306 that the migration processing is not necessary, the management program 121 terminates the update processing.

If it is determined in step S307 that the allocated machine has been found, the management program 121 schedules an execution date to execute migration (S308). Specifically speaking, the management program 121 updates the schedule table 131 and the schedule virtual server system related table 135.

On the other hand, if it is determined in step S307 that the allocated machine has not been found, the management program 121 notifies the user that the server computer 200 or the storage apparatus 300 which satisfies the change request cannot be allocated (S309).

Incidentally, during the update processing of FIG. 27, the server computer search processing (S303) and the disk search processing (S305) are executed separately and the disk search processing is executed after the execution of the server computer search processing; however, the invention is not limited to this example. For example, the disk search processing may be executed before the server computer search processing according to the user's selection.

For example, if the search according to the search policy is to be preferentially executed in response to a server resource request, the server computer search processing is executed before the disk search processing. Moreover, if the search according to the search policy is to be preferentially executed in response to a disk capacity request, the disk search processing is executed before the server computer search processing. For example, the search policy priority may be set by storing the priority order in the user selection column 1474 of the search policy table in FIG. 24.

### (1-4-4) Migration Processing

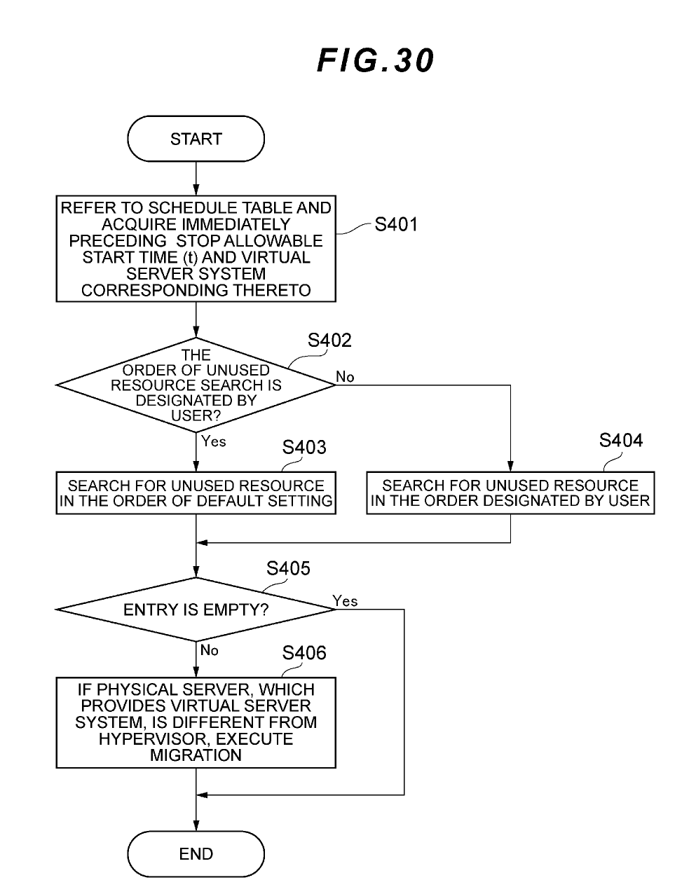

Next, the migration processing will be explained with reference to FIG. 30. The migration processing is executed on the server computer or the disk searched by the aforementioned full server computer search processing in step 315 or the full disk search processing in step 325 on the migration execution date scheduled in step S308.

The management program 121 acquires immediately preceding system stop allowable start time and the virtual server system 500 which is a migration target, as illustrated in FIG. 30 (S401). Specifically speaking, the management program 121 refers to the schedule table 131; and when time that is set to the schedule table 131 comes, the management program 121 acquires the ID of a virtual server system 500 corresponding to the ID of the schedule table from the schedule virtual server system related table 135.

Then, the management program 121 judges whether the order of an unused resource search for searching, for example, the resource or the disk capacity is designated by the user or not (S402).

If it is determined in step S402 that the order of the unused resource search is not designated by the user, the management program 121 searches for an unused resource in the order of preset default settings (S403). Specifically speaking, the management program 121 refers to the hypervisor table 136, sorts entries in the order of the CPU grade, the number of unused cores, and the unused memory capacity, which is the order of default settings, and then selects the highest entry.

On the other hand, if it is determined in step S402 that the order of the unused resource search is designated by the user, the management program 121 searches for the unused resource in the order designated by the user (S404). Specifically speaking, the management program 121 refers to the hypervisor table 136, sorts entries in the order designated by the user, for example, in the order of the CPU grade, the unused memory capacity, and the number of unused cores, and selects the highest entry.

Then, the management program 121 judges whether the entry of the hypervisor table 136, which was selected in step S403 or step S404, is an empty entry or not (S405).

If the entry selected in step S405 is an empty entry, this means that there is no hypervisor 221 which can be selected; and, therefore, the management program 121 terminates the migration processing.

On the other hand, if it is determined in step S405 that the selected entry is not an empty entry and the hypervisor 221 is different from the physical server of the server computer 200 which provides the virtual server system 500 that is the migration target, the migration processing is executed (S406). The migration processing has been explained as described above.

### (1-5) Management Display

Next, a management display displayed on a display device of the management server 100 will be explained. The administrator of the management server 100 changes the settlings of the virtual server system 500 and checks a resource and disk allocation status after changing the settings of the system via the management display in response to a system change request from the user.

### (1-5-1) Template Edit Display

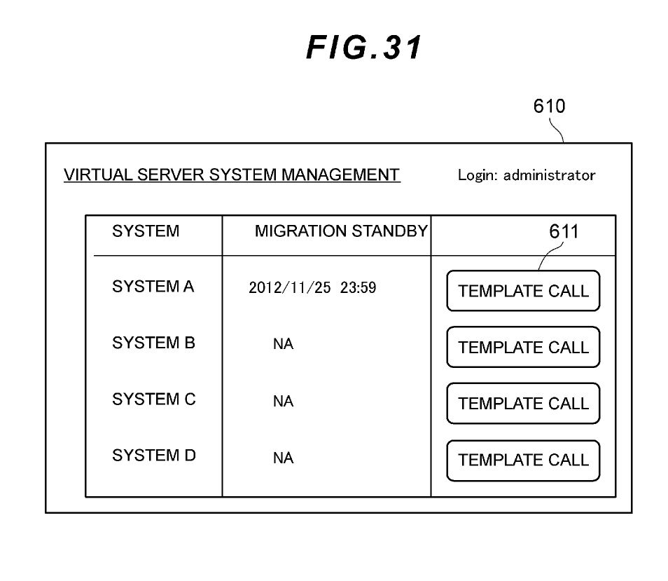

FIG. 31 is a conceptual diagram showing an example of a virtual server system management display 610. The virtual server system management display 610 is a screen for managing, for example, setting changes of each virtual server system 500; and as illustrated in FIG. 31, a template call button 611 is selected to call a template of the virtual server system 500 which is a system change target.

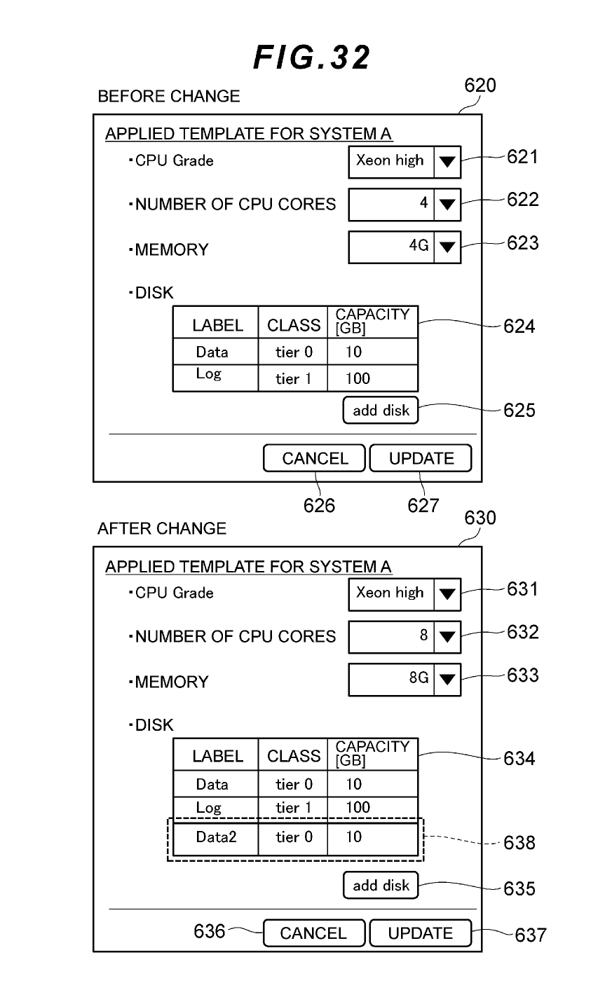

FIG. 32 is a conceptual diagram showing an example of template edit displays 620, 630. The template edit display 620 is a screen for displaying a template in which resources and disks for the selected virtual server system 500 are set. FIG. 32 shows a template for System A. The administrator changes, for example, the resources for the virtual server system 500 by changing values of the resources and disks displayed on the template edit display 520. For example, the CPU grade is selected by using a pull-down button 621, the number of CPU cores is selected by using a pull-down button 622, and the memory capacity is selected by using a pull-down button 623.

Furthermore, the administrator changes the settings of the disks by changing the capacity which is set to a disk setting list 624, adding a new entry to the disk setting list 624, and pressing an additional disk button (indicated as “Add Disk” in the drawing) 625. Then, the administrator can make various setting changes of the template edit display 620 reflected in the virtual server system 500 by pressing an update button 627.

For example, as shown in the template edit display 630, the number of CPU cores is enhanced from 4 to 8, the memory capacity is enhanced from 4 GB to 8 GB, and regarding the disk capacity, the capacity of the highest tier Tier 0 for data type Data 2 is enhanced by 10 GB by the administrator. The administrator issues the above-described setting change instruction by pressing an update button 37.

### (1-6) Advantageous Effects of this Embodiment

According to this embodiment as described above, the management program 121 of the management server 100: changes a template, in which the resource type and the resource amount are set, in accordance with a request to change the physical resources for the server computer 200 and the storage apparatus 300, which are allocated to the storage system 500; calculates the difference for each resource type between resource amounts before and after the change of the template; and searches for a server computer 200 or a storage apparatus 300, to which the difference of the calculated resource amount can be allocated, based on a search policy for the physical resources which are set to minimize cost for the system change. The search policy is the order to search for a device, which would minimize the cost, in response to the user's request and may be set according to a setting environment of the virtual server system 500 or may be previously set by the user or the administrator. Regarding a search method, for example, a server computer 200, which is the same as the server computer 200 currently providing the physical resources to the virtual server system 500, or a storage apparatus 300, which is the same as the storage apparatus 300, may be preferentially searched; a server computer 200 of the same hypervisor group may be preferentially searched; a high-speed-connection device may be preferentially searched; or a device having a high fragmentation effect may be preferentially searched.

Accordingly, if the request is satisfied by only the system setting change when changing the software configuration of the virtual server system 500, it is only necessary to just change the system settings without performing the migration. So, it is possible to reduce loads, which are associated with the change of the software configuration, on the system.

### (2) Second Embodiment

Next, a second embodiment will be explained. A detailed explanation about the same configuration as that of the aforementioned first embodiment has been omitted and configurations different from those of the first embodiment will be explained particularly in detail.

(2-1) Outline of this Embodiment

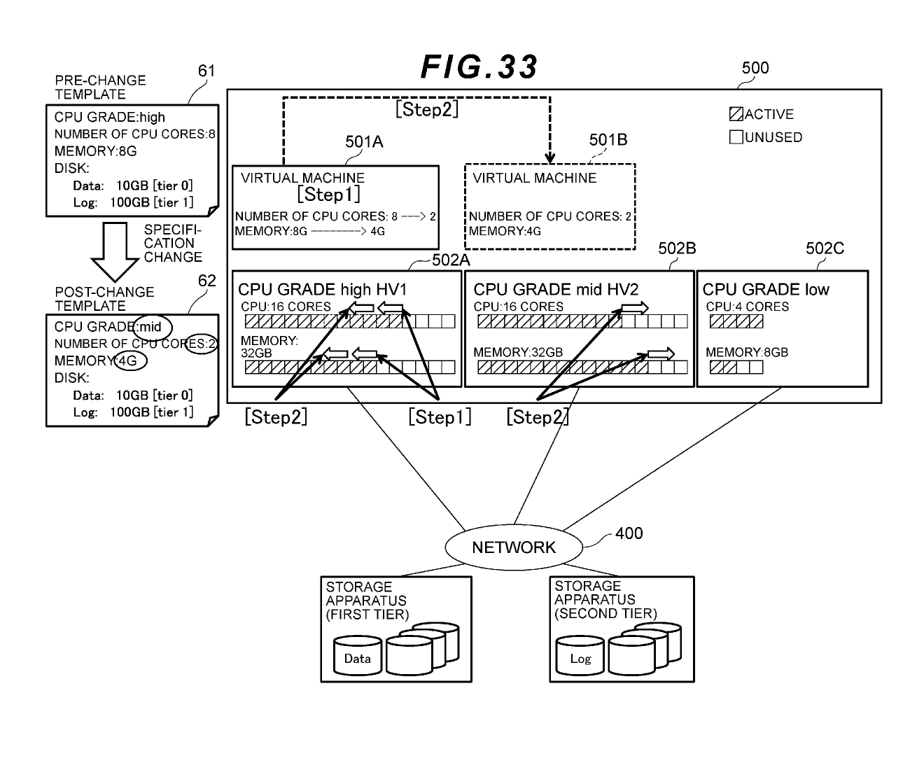

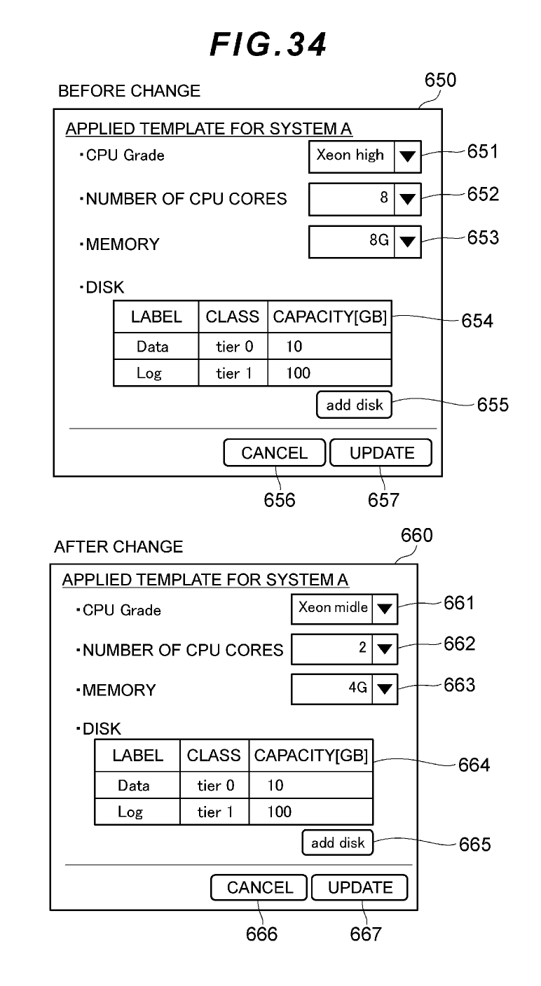

The outline of this embodiment will be explained with reference to FIG. 34. FIG. 33 shows a case of a specification reduction of the resources for the virtual server system 500. A template 61 showing the settings of each resource is changed to a template 62 in accordance with specifications requested by the user. For example, the CPU grade is changed from a high grade to a middle grade, the number of CPU cores is changed from 8 to 4, and the memory capacity is changed from 8 GB to 4 GB.

When the template is changed, the resources are allocated according the setting change of the virtual server system 500 to satisfy the setting content of the post-change template 62. For example, the number of CPU cores and memory capacity after the change are reallocated to the virtual server system 500 which is the change target.

Furthermore, in this embodiment, a physical server which is a migration destination of the physical server allocated to the virtual server system 500 is searched in order to resolve the fragmentation; and if the physical server which is the migration destination is found by the search, the migration is executed. A stop allowable time period for the system is set in advance upon prior agreement with the user and this migration is executed every time the stop allowable time period of the system comes.

For example, if an unused resource of a physical server, which is of a lower grade than that of the physical server currently provided to the virtual server system 500, can be allocated upon a change request to the virtual server system 500, the physical server currently provided to the virtual server system 500 is migrated to the low-grade physical server, so that the high-grade physical server can be utilized effectively.

Since the hardware configuration and software configuration of the computer system are the same as those of the first embodiment, any detailed explanation about them has been omitted.

### (2-2) Management Display

### (2-2-1) Template Edit Display

Next, a management display displayed on the display device of the management server 100 will be explained. Since template edit displays 650 and 660 shown in FIG. 34 are the same as the template edit displays 620 and 630 explained earlier, any detailed explanation about them has been omitted.

With the template edit displays 650 and 660, resources or the like of the virtual server system 500 are changed; and particularly, a case of resource reduction is shown. For example, the administrator lowers the CPU grade from a high grade to a middle grade, reduces the number of CPU cores from 8 to 4, and reduces the memory capacity from 8 GB to 4 GB. The administrator gives the instruction to change the above settings by pressing an update button 665.

### (2-2-2) Migration Check Display

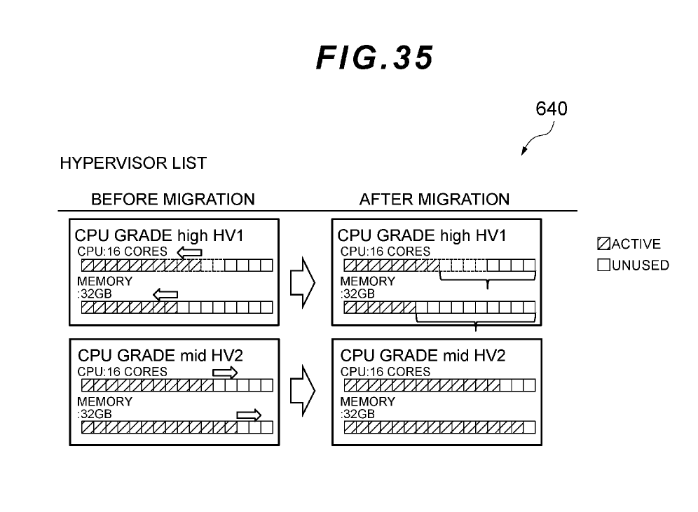

Next, a check display for checking a migration effect when executing the above-described setting change and further migrating the allocated resources and disks to resources and disks of a low-grade physical server will be explained. FIG. 35 is an example of a check display 640 for checking the migration effect after executing the migration. As a result of comparison of the CPU before and after the migration as illustrated in FIG. 35, it is shown that unallocated resources of a physical machine of a high CPU grade have increased after the migration.

(2-3) Advantageous Effects of this Embodiment

When a system change to reduce resources or the like is executed and the resources are migrated to, for example, a low-grade physical resource according to this embodiment as described above, migration cost can be curbed and unused resources can be utilized effectively (suppression of fragmentation). Furthermore, as the above-described migration processing is executed during a time period which would not affect normal work even if a business system is stopped, it is possible to promptly deal with a system change request from the user and allocate an appropriate resource to a virtual server system without affecting the normal work.

### REFERENCE SIGNS LIST

100 management server
110 CPU
120 primary storage device
121 management program
130 secondary storage device
200 server computer
210 CPU
220 primary storage device
221 hypervisor
230 secondary storage device
300 storage apparatus
310 controller
312 disk

1. A management system comprising:
a memory unit for storing a plurality of templates including a resource type and resource amount of physical resources of a plurality of physical computers allocated to a virtual machine; and
a control unit for controlling allocation of the physical resources to the virtual machine;
wherein each of the plurality of physical computers has the physical resources and executes a hypervisor for controlling the virtual machine; and
wherein the management system:
receives a virtual machine generation request which designates one template of the plurality of templates;
searches for the physical computer having the physical resources included in the template;
sends a resource allocation request to the searched physical computer in accordance with the received virtual machine generation request and the template;
collects a resource usage status of each physical computer;
receives an identifier of a generated virtual machine and a change request to change the template;
calculates a resource type and resource amount, which need to be added by changing the template, based on the collected resource usage status;
judges whether a first physical computer for controlling the generated virtual machine has the additional resource amount of the calculated resource type as an unused resource amount or not;
sends a request to the first physical computer to additionally allocate the calculated additional resource amount from the unused resource amount, which the first physical computer has, to the generated virtual machine if the first physical computer has the additional resource amount as the unused resource amount; and
sends an operation instruction to additionally allocate the calculated additional resource amount to the generated virtual machine if the first physical computer does not have the additional resource amount as the unused resource amount.

2. The management system according to claim 1, wherein if the first physical computer does not have the additional resource amount as the unused resource amount, the management system searches for a second physical computer, which has the resource amount described in the changed template as the unused resource, and sends an instruction to the first physical computer or the second physical computer to migrate the generated virtual machine.

3. The management system according to claim 2, wherein the management system:
receives the identifier of the generated virtual machine and the change request to change the template;
calculates a resource type and resource amount, which should be deleted, by changing the template;
sends a deletion request to the physical computer for controlling the generated virtual machine to delete the resource amount of the virtual machine; and
searches for a third physical computer, which has an appropriate resource amount for the resource mount of the generated virtual machine after the deletion, and sends an instruction to the third physical computer to migrate the generated virtual machine, asynchronously with the deletion request.

4. The management system according to claim 3, wherein during a stop allowable time period of each virtual machine which is preset upon an agreement with a user, the management system searches for the third physical computer, which has the appropriate resource amount for the resource mount of the generated virtual machine after the deletion, and sends the instruction to the third physical computer to migrate the generated virtual machine.

5. The management system according to claim 4, wherein the management system searches for the third physical computer, which has the appropriate resource amount for the resource mount of the generated virtual machine after the deletion, based on priority designated by the user.

6. The management system according to claim 5, wherein the management system searches for the third physical computer, which has the appropriate resource amount for the resource mount of the generated virtual machine after the deletion, in the order of a CPU grade, the number of unused cores, and an unused memory amount of the physical computer.

7. A management program for having a computer function as a management system including:
a memory unit for storing a plurality of templates including a resource type and resource amount of physical resources of a plurality of physical computers allocated to a virtual machine; and
a control unit for controlling allocation of the physical resources to the virtual machine;
wherein each of the plurality of physical computers has the physical resources and executes a hypervisor for controlling the virtual machine; and
wherein the management system:
receives a virtual machine generation request which designates one template of the plurality of templates;
searches for the physical computer having the physical resources included in the template;
sends a resource allocation request to the searched physical computer in accordance with the received virtual machine generation request and the template;
collects a resource usage status of each physical computer;
receives an identifier of a generated virtual machine and a change request to change the template;
calculates a resource type and resource amount, which need to be added by changing the template, based on the collected resource usage status;
judges whether a first physical computer for controlling the generated virtual machine has the additional resource amount of the calculated resource type as an unused resource amount or not;
sends a request to the first physical computer to additionally allocate the calculated additional resource amount from the unused resource amount, which the first physical computer has, to the generated virtual machine if the first physical computer has the additional resource amount as the unused resource amount; and
sends an operation instruction to additionally allocate the calculated additional resource amount to the generated virtual machine if the first physical computer does not have the additional resource amount as the unused resource amount.

8. The management program according to claim 7, wherein if the first physical computer does not have the additional resource amount as the unused resource amount, the management system searches for a second physical computer, which has the resource amount described in the changed template as the unused resource, and sends an instruction to the first physical computer or the second physical computer to migrate the generated virtual machine.

9. The management program according to claim 7, wherein the management system:
receives the identifier of the generated virtual machine and the change request to change the template;
calculates a resource type and resource amount, which should be deleted, by changing the template;
sends a deletion request to the physical computer for controlling the generated virtual machine to delete the resource amount of the virtual machine; and
searches for a third physical computer, which has an appropriate resource amount for the resource mount of the generated virtual machine after the deletion, and sends an instruction to the third physical computer to migrate the generated virtual machine, asynchronously with the deletion request.

10. The management program according to claim 9, wherein during a stop allowable time period of each virtual machine which is preset upon an agreement with a user, the management system searches for the third physical computer, which has the appropriate resource amount for the resource mount of the generated virtual machine after the deletion, and sends the instruction to the third physical computer to migrate the generated virtual machine.

11. The management program according to claim 9, wherein the management system searches for the third physical computer, which has the appropriate resource amount for the resource mount of the generated virtual machine after the deletion, based on priority designated by the user.

12. The management program according to claim 9, wherein the management system searches for the third physical computer, which has the appropriate resource amount for the resource mount of the generated virtual machine after the deletion, in the order of a CPU grade, the number of unused cores, and an unused memory amount of the physical computer.
